(19) United States
(12) Patent Application Publication
(10) Pub. No.: US 2025/0336385 A1
(43) Pub. Date: Oct. 30, 2025

(54) SYSTEMS, DEVICES, AND METHODS FOR PHASE SHIFTING SOUND WAVES PROPAGATING THROUGH A FLUID

(71) Applicant: Black & Decker, Inc., New Britain, CT (US)

(72) Inventors: Madison MORRISON, Hermosa Beach, CA (US); Michael CHACON, Gardena, CA (US); Andrew PALACIO, Cranford, NJ (US); Leen ALFAOURY, Baltimore, MD (US); Yensabro KANASHIRO, Baltimore, MD (US); Stephen BELKOFF, Baldwin, MD (US); Richard BAUERNSCHUB, Ellicott City, MD (US); Nathan GREENE, Baltimore, MD (US); Ethan HELMER, Rising Sun, MD (US)

(21) Appl. No.: 19/189,719

(22) Filed: Apr. 25, 2025

Related U.S. Application Data
(60) Provisional application No. 63/639,932, filed on Apr. 29, 2024.

(51) Int. Cl. G10K 11/178

(52) U.S. Cl. CPC G10K 11/17815; G10K 2210/109; G10K 2210/3025; G10K 2210/3044

(57) ABSTRACT

An exemplary noise reducing device for reducing the noise of sound waves propagating through a fluid includes a housing; a primary flow path within the housing configured to receive a first portion of the fluid; and at least one phase shifting flow path within the housing configured to receive a second portion of the fluid, wherein the first portion of the fluid flowing through the primary flow path produces a first sound wave, and wherein the second portion of the fluid flowing through the phase shifting flow path produces a second sound wave out of phase relative to the first sound wave at a target frequency, such that the first sound wave destructively interferes with the second sound wave to reduce noise of the first and second sound waves.

### CROSS REFERENCE TO RELATED APPLICATIONS

This application claims benefit of U.S. Provisional Application No. 63/639,932, filed Apr. 29, 2024, the entire contents of which is incorporated herein by reference.

### FIELD

This disclosure relates generally to noise cancellation devices for fluid flow devices and more specifically to noise cancellation using destructive interference by phase shifting sound waves in a fluid flow.

### BACKGROUND

Devices such as blowers (e.g., leaf blowers), fans, vacuums, blow dryers/hair dryers, and so on are ubiquitous in daily life. Such devices often generate loud noises that can be disruptive, bothersome, and even harmful to the human ear. Accordingly, devices and methods for mitigating the noise generated by such devices are desirable.

### SUMMARY

Disclosed herein are noise reducing devices and methods that shift acoustic wave phases in at least a portion of a fluid flow such that the sound waves in that portion destructively interfere with sound waves in another portion of the fluid flow. The devices and methods described herein can be used to reduce the noise generated by devices such as leaf blowers, fans, hair dryers, and so on, described above. When two acoustic waves are in-phase such that their peak pressures align, the result is constructive interference and amplification of the noise. In contrast, when two acoustic waves are out of phase such that one wave's pressure peaks align with the other wave's pressure valleys (decreased pressure regions), the result is destructive interference and noise reduction. The devices and methods described herein create this type of destructive interference by shifting the acoustic wave phases in at least a portion of a fluid flow. The devices and methods may shift a phase of sound waves in a portion of a fluid flow such that the sound waves are 180 degrees out of phase with corresponding sound waves (those of the same frequency) in another portion of a fluid flow.

An exemplary noise reducing device for phase shifting sound waves propagating through a fluid includes a housing, a primary flow path, and at least one phase shifting flow path within the housing. The primary flow path extends from a primary inlet to a primary outlet and is configured to receive a first portion of a fluid flow. The at least one phase shifting flow path extends from at least one secondary inlet to at least one secondary outlet and is configured to receive a second portion of the fluid. The primary flow path may be configured such that at least a first sound wave is produced by the first portion of the fluid flowing through the primary flow path. The at least one phase shifting flow path may be configured such that at least a second sound wave is produced by the second portion of the fluid flowing through the at least one phase shifting flow path. The at least one phase shifting flow path may be configured such that the second sound wave is out of phase (e.g., phase shifted by approximately 180 degrees) relative to the first sound wave. When the first and second portion of the fluid flow exit the device, the first sound wave and second sound wave destructively interfere with one another, thus reducing noise.

An exemplary noise reducing device for reducing the noise of sound waves propagating through a fluid comprises: a housing; a primary flow path within the housing extending from a primary inlet to a primary outlet, the primary flow path configured to receive a first portion of the fluid; and at least one phase shifting flow path within the housing extending from at least one secondary inlet to at least one secondary outlet, the at least one phase shifting flow path configured to receive a second portion of the fluid, wherein the primary flow path is configured such that the first portion of the fluid flowing through the primary flow path produces a first sound wave, and wherein the at least one phase shifting flow path is configured such that the second portion of the fluid flowing through the phase shifting flow path produces a second sound wave out of phase relative to the first sound wave, such that the second sound wave destructively interferes with the first sound wave to reduce noise of the first sound wave.

In some embodiments, producing the second sound wave out of phase relative to the first sound wave causes the first sound wave and second sound wave to destructively interfere with one another downstream of the housing.

In some embodiments, the at least one phase shifting flow path comprises a helical portion that extends along at least a portion of the housing between the at least one secondary inlet and the at least one secondary outlet.

In some embodiments, the helical portion of the at least one phase shifting flow path extends helically around the primary flow path.

In some embodiments, the at least one phase shifting flow path is positioned radially outward of the primary flow path on the device.

In some embodiments, a length of the at least one phase shifting flow path is greater than a length of the primary flow path.

In some embodiments, the phase shifting flow path is configured to produce the second sound wave such that it is 180 degrees out of phase relative to the first sound wave.

In some embodiments, the first and second sound waves comprise frequencies between 1.5 kHz and 5.5 kHz.

In some embodiments, the first and second sound waves comprise frequencies between 2 kHz and 5 kHz.

In some embodiments, a length of the at least one phase shifting flow path is greater than a wavelength of the first sound wave.

In some embodiments, the second portion of the fluid flowing through the at least one phase shifting flow path produces a first plurality of sound waves that are out of phase with a second plurality of sound waves produced by the first portion of the fluid flowing through the primary flow path such that the first and second plurality of sound waves destructively interfere with one another downstream of the device.

In some embodiments, the secondary inlet of the at least one phase shifting flow path is positioned at the same longitudinal location as the primary inlet on an inlet surface of the housing.

In some embodiments, the housing comprises a fillet or a chamfer at an edge between the inlet surface and the respective secondary inlet of the at least one phase shifting flow path.

In some embodiments, the secondary outlet of the at least one phase shifting flow path is positioned at the same longitudinal location as the primary outlet on an outlet surface of the housing.

In some embodiments, the secondary outlet of the at least one phase shifting flow path is positioned radially outward of the primary outlet on the outlet surface of the housing.

In some embodiments, the secondary outlet of the at least one phase shifting flow path is configured such that the second portion of the fluid combines with the first portion of the fluid downstream of the secondary outlet of the at least one phase shifting flow path.

In some embodiments, the device is configured to be attached to a blower tube.

In some embodiments, the device is configured to be attached to an intake of a blower apparatus.

In some embodiments, the fluid comprises air.

An exemplary method for phase shifting sound waves propagating through a fluid comprises: receiving a fluid at a device for phase shifting sound waves propagating through the fluid, the device comprising: a housing; a primary flow path extending from a primary inlet to a primary outlet; and at least one phase shifting flow path comprising a secondary inlet and a secondary outlet; receiving a first portion of the fluid into the primary flow path via the primary inlet; receiving a second portion of the fluid into the at least one phase shifting flow path via the secondary inlet; shifting a phase of the at least one sound wave propagating through the second portion of the fluid such that the at least one sound wave is out of phase with a corresponding sound wave propagating through the first portion of the fluid.

In some embodiments, the method comprises: directing the first portion of the fluid flow out of the primary outlet; and directing the second portion of the fluid out of the secondary outlet such that the at least one sound wave destructively interferes with the corresponding sound wave downstream of the primary outlet and the secondary outlet.

In some embodiments, the primary outlet and the secondary outlet are located on a rear surface of the device and configured such that the first portion of the fluid and the second portion of the fluid combine downstream of the primary outlet and the secondary outlet.

In some embodiments, the at least one phase shifting flow path extends helically along at least a portion of the housing between the secondary inlet and the secondary outlet.

An exemplary noise reducing device comprises: a housing; a primary flow path along a central portion of the housing extending from a primary inlet to a primary outlet, the primary flow path producing a first sound wave; and a secondary air flow helically surrounding the primary air flow path, extending from at least one secondary inlet to at least one secondary outlet, the secondary air flow path producing a second sound wave; wherein the second sound wave is phase shifted from the first sound wave.

In some embodiments, any one or more of the characteristics of any one or more of the systems, methods, and/or devices recited above may be combined, in whole or in part, with one another and/or with any other features or characteristics described elsewhere herein.

### BRIEF DESCRIPTION OF THE FIGURES

The patent or application file contains at least one drawing executed in color. Copies of this patent or patent application publication with color drawing(s) will be provided by the Office upon request and payment of the necessary fee.

A better understanding of the features and advantages of the present disclosure will be obtained by reference to the following detailed description that sets forth illustrative embodiments, in which the principles of the disclosure are utilized, and the accompanying drawings of which:

FIG. 1A illustrates an isometric view of an inlet end of a noise reducing device for phase shifting sound waves having phase shifting flow paths with rectangular cross-sectional profiles according to some embodiments.

FIG. 1B illustrates a side section view of the device of FIG. 1A according to some embodiments.

FIG. 1C illustrates a transparent side view of the device of FIGS. 1A and 1B depicting a helical shape of the phase shifting flow paths according to some embodiments.

FIG. 2A illustrates an isometric view of an inlet end of a noise reducing device for phase shifting sound waves having phase shifting flow paths extending from tapered inlets positioned at a front surface of the device according to some embodiments.

FIG. 2B illustrates a side section view of the noise reducing device of FIG. 2A according to some embodiments.

FIG. 2C illustrates a transparent side view of the device of FIGS. 2A and 2B depicting a helical shape of the phase shifting flow paths according to some embodiments.

FIG. 3 illustrates a noise reducing device for phase shifting sound waves having a fillet at the inlet of the primary and phase shifting flow paths according to some embodiments.

FIG. 4A illustrates an isometric view of an inlet end of a noise reducing device having additional phase shifting flow paths relative to the devices of FIGS. 1A-3 according to some embodiments.

FIG. 4B illustrates an isometric view of an outlet end of a noise reducing device according to some embodiments.

FIG. 4C illustrates a section view of the noise reducing device of FIG. 4B according to some embodiments.

FIG. 4D illustrates a graph of noise canceling performance at different frequencies for the device of FIGS. 4A-4C according to some embodiments.

FIG. 5A illustrates a top view of a noise reducing device for phase shifting sound waves having multiple layers of phase shifting flow paths according to some embodiments.

FIG. 5B illustrates a section view of the noise reducing device of FIG. 5A according to some embodiments.

FIG. 5C illustrates a front view of an inlet end of the noise reducing device of FIG. 5A according to some embodiments.

FIG. 5D illustrates an isometric view of an inlet end of the noise reducing device of FIG. 5A according to some embodiments.

FIG. 5E illustrates an isometric view of an outlet end of the noise reducing device of FIG. 5A according to some embodiments.

FIG. 6 illustrates a table of exemplary design alternatives for noise reducing devices according to some embodiments.

FIG. 7A illustrates a side view of a noise reducing device attached to an end of a blower tube/conduit of a leaf blower according to some embodiments.

FIG. 7B illustrates a top view of a noise reducing device attached to an end of a blower tube/conduit of a leaf blower according to some embodiments.

FIG. 7C illustrates an exemplary intake of a blower device to which a noise reducing device may be mounted according to some embodiments.

FIG. 8A illustrates a front view of a noise reducing device configured to be mounted to an intake of a blower device according to some embodiments.

FIG. 8B illustrates an isometric view of an inlet end of the noise reducing device of FIG. 8A according to some embodiments.

FIG. 8C illustrates a semi-transparent side section view of the noise reducing device of FIG. 8A according to some embodiments.

FIG. 8D illustrates an isometric view of an outlet end of the noise reducing device of FIG. 8A according to some embodiments.

FIG. 9A illustrates an inlet end of a noise reducing device configured to be mounted to an intake of a blower device according to some embodiments.

FIG. 9B illustrates an isometric view of the inlet end of the noise reducing device of FIG. 9A according to some embodiments.

FIG. 9C illustrates a side section view of the noise reducing device of FIG. 9A according to some embodiments.

FIG. 10 illustrates an exemplary method for phase shifting sound waves according to some embodiments.

FIG. 11A illustrates a fluid flow simulation through an example noise reducing device according to some embodiments.

FIG. 11B illustrates the fluid flow simulation of FIG. 11A with additional detail regarding the flow upstream of the inlets and downstream of the outlets.

FIG. 11C illustrates a section view of the phase shifting device used for the fluid flow simulation of FIGS. 11A and 11B.

FIG. 11D illustrates an isometric view of the fluid flow simulation of FIGS. 11A-11C.

FIG. 12A illustrates an exemplary noise reducing device according to some embodiments.

FIG. 12B illustrates a front view of the exemplary noise reducing device of FIG. 12A according to some embodiments.

FIG. 12C illustrates a section view of the exemplary noise reducing device of FIG. 12A according to some embodiments.

FIG. 13A illustrates an exemplary noise reducing device according to some embodiments.

FIG. 13B illustrates a front view of the exemplary noise reducing device of FIG. 13A according to some embodiments.

FIG. 13C illustrates a section view of the exemplary noise reducing device of FIG. 13A according to some embodiments.

### DETAILED DESCRIPTION

Described herein are devices and methods for noise cancelation that shift acoustic wave phases in at least a portion of a fluid flow such that the sound waves in that portion destructively interfere with sound waves in another portion of the fluid flow. The devices and methods described herein may be used for noise reduction for a variety of common devices, such as leaf blowers, hair dryers, vacuums, etc. An exemplary device for phase shifting sound waves to reduce noise in a fluid flow may include a housing, a primary flow path within the housing, and at least one phase shifting flow path within the housing. The housing may be configured such that it can be removably attached (e.g., friction fit or otherwise mechanically fastened), permanently connected to, and/or may be integral to fluid flow conduits of devices such as leaf blowers, hair dryers, vacuums, etc.

The primary flow path within the housing may extend from a primary inlet to a primary outlet and may be configured to receive a first portion of the fluid. The primary inlet may be positioned at an inlet end of the housing and the primary outlet may be positioned on an outlet end downstream of the inlet end. The primary flow path may be centrally located within the housing such that its central axis is aligned with a central axis of a connected fluid flow conduit. The at least one phase shifting flow path may be configured to receive a second portion of the fluid and may extend within the housing from at least one secondary inlet to at least one secondary outlet. The primary flow path may be configured such that at least a first sound wave is produced by the first portion of the fluid flowing through the primary flow path. The at least one phase shifting flow path may be configured such that at least a second sound wave is produced by the second portion of the fluid flowing through the at least one phase shifting flow path. The at least one phase shifting flow path may be configured such that the second sound wave is out of phase (e.g., phase shifted by approximately 180 degrees) relative to the first sound wave.

The at least one phase shifting flow path may include a helical portion that extends along at least a portion of the housing between the at least one secondary inlet and the at least one secondary outlet. The helical portion of the at least one phase shifting flow path may extend helically around the centrally located primary flow path. The at least one phase shifting flow path may be positioned radially outward of the primary flow path on the device and a length of the at least one phase shifting flow path may be greater than that of the primary flow path. The target frequencies that the phase shifting flow path(s) are configured to phase shift may be a function of the length of the phase shifting flow paths. For example, the phase shifting flow paths may be configured such that their length is greater than (e.g., 1.5 times, 2.5 times, 3.5 times) the wavelength of a sound wave having a target frequency (e.g., between 2-5 kHz) propagating within the primary flow path. This may result in a phase shift of 180 degrees, thus creating destructive interference as the air flowing through the phase shifting pathways combines with the air flowing through the primary flow path at the target frequency. It should be understood that any half-wavelength difference in length between the primary flow path and phase shifting flow path(s) may result in a 180 degree phase shift to create destructive interference. Additionally, in some examples, destructive interference may also occur within the noise reducing devices described herein.

The phase shifting pathways can be configured to target specific frequencies that are most bothersome to the human ear, thus resulting in both overall noise reduction as well as a more pleasant sound. Humans can detect sounds in frequency ranges from 20 Hz to about 20 kHz. However, while the audible spectrum has a wide range, the most unpleasant frequencies to the human ear are between 2 to 5 kHz. That is, the human ear is most sensitive to frequencies between 2 to 5 kHz. As described above, the frequencies targeted by the devices described herein are a function of the length of the phase shifting flow paths. The length of the phase shifting flow paths can optionally be configured to phase shift sound waves at frequencies between 2 to 5 kHz, thus targeting the device's noise canceling effects on the most bothersome frequencies.

In the following description of the various embodiments, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating,” or the like, refer to the action and processes of a computer system, or similar electronic computing device, that manipulates and transforms data represented as physical (electronic) quantities within the computer system memories or registers or other such information storage, transmission, or display devices.

The present disclosure in some embodiments also relates to a device for performing the operations herein. This device may be specially constructed for the required purposes, or it may comprise a general-purpose computer selectively activated or reconfigured by a computer program stored in the computer. Such a computer program may be stored in a non-transitory, computer readable storage medium, such as, but not limited to, any type of disk, including floppy disks, USB flash drives, external hard drives, optical disks, CD-ROMs, magnetic-optical disks, read-only memories (ROMs), random access memories (RAMs), EPROMS, EEPROMs, magnetic or optical cards, application specific integrated circuits (ASICs), or any type of media suitable for storing electronic instructions, and each connected to a computer system bus. Furthermore, the computing systems referred to in the specification may include a single processor or may be architectures employing multiple processor designs, such as for performing different functions or for increased computing capability. Suitable processors include central processing units (CPUs), graphical processing units (GPUs), field programmable gate arrays (FPGAs), and ASICs.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The structure for a variety of these systems will appear from the description below. In addition, the present invention is not described with reference to any particular programming language. It will be appreciated that a variety of programming languages may be used to implement the teachings of the present disclosure as described herein.

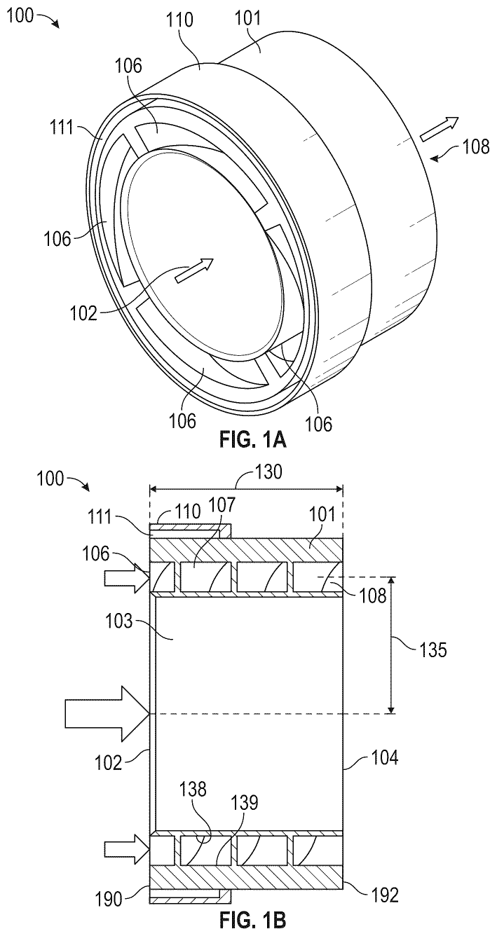

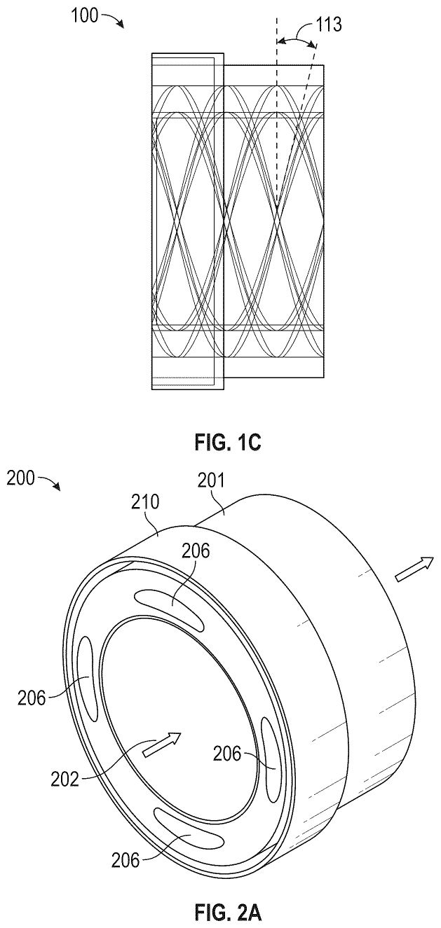

FIGS. 1A-1C illustrate an exemplary device 100 configured to phase shift sound waves propagating through a fluid flowing through the device. FIG. 1A illustrates an isometric view of device 100. The device 100 includes a housing 101. Housing 101 includes a primary fluid flow inlet 102 leading to a primary flow path 103, which may be a hollow tube, duct, or other conduit extending along the length of device 100 from primary inlet 102. Device 100 also includes at least one secondary inlet 106 that leads to at least one helical phase shifting flow path 107 within the housing 101. As shown, device 100 includes four secondary inlets 106 leading to four respective phase shifting flow paths; although it should be understood that additional or fewer phase shifting flow paths and corresponding secondary inlets fall within the scope of this disclosure.

FIG. 1B illustrates a section view of device 100 that provides a more detailed depiction of the internal structure of the primary flow path 103 and phase shifting flow paths 107. Primary flow path 103 extends along the length of device 100 from primary inlet 102 to primary outlet 104. The phase shifting flow paths 107 and corresponding secondary inlets are positioned radially outward of the primary flow path 103 and inlet 102. The secondary inlets 106 to phase shifting flow paths 107 are positioned at the same longitudinal location (e.g., at inlet surface 190 of housing 101) as the primary inlet 102. The phase shifting flow paths 107 may include a helical portion that extends helically along the length of the housing 101 between the at least one secondary inlet 106 and at least one secondary outlet 108. The secondary outlets 108 of the phase shifting flow paths 107 are positioned at the same longitudinal location as the primary outlet 104 on an outlet surface 192 of the housing 101. The helical portion of the phase shifting flow paths 107 may extend helically around the primary flow path 102, helically coiled about a longitudinal axis 181 of device 100 between the inlet surface 190 and outlet surface 192.

The primary flow path 103 is configured to receive a first portion of a fluid flow, and the at least one phase shifting flow path 107 is configured to receive a second portion of the fluid flow. One or more sound waves may propagate within the first and second portions of the fluid flow. For instance, a first portion of the fluid flow may enter the primary flow path 103. A first sound wave may be produced by the first portion of fluid flowing through the primary flow path 103 and may propagate within the first portion of the fluid flow. A second portion of the fluid flow may enter the at least one phase shifting flow path 107, and a second sound wave may be produced by the second portion of the fluid flowing through the at least one phase shifting flow path 107 and may propagate within the second portion of the fluid. The phase shifting flow path 107 may be configured such that the second sound wave is shifted out of phase (approximately 180 degrees) from the first sound wave. Thus, when the first and second portion of the fluid flow recombine downstream of device 100 (e.g., downstream of primary outlet 104 and secondary outlets 108), the first and second sound wave destructively interfere with one another. The sound waves the device is configured to phase shift may include a target frequency. The target frequency may be within the audible frequency range (e.g., between 20 Hz and 20 kHz). In some examples, the at least one target frequency is between 2 kHz and 5 kHz (the most unpleasant frequencies to the human ear). Thus, device 100 is configured to generate destructively interfering sound waves targeting certain frequencies that are most unpleasant to the human ear.

The length 130 of the device 100, the helix angle 113 of the helical portion of the phase shifting paths 107 (shown in FIG. 1C), and/or the radius 135 of the helical portion can be adjusted such that the phase shifting flow paths 107 may be configured to target certain frequencies. A helix's pathway length, L, can be calculated according to equation 1:

$$L = n \sqrt{{C}^{2} + {p}^{2}} \qquad ( 1 )$$

where n is the number of helical revolutions, C is the mean circumference of the helical pathway, and p is the pitch of the helix. The circumference may be calculated by using the mean radius of the helix, e.g., radius 135 of FIG. 1B. In some examples, each helix of the phase shifting flow paths 107 of device 100 achieves one full rotation. Accordingly, the helix pitch (the height of one helical revolution measured parallel to the axis of the helix) may be equal to the total length of the device 100. However, it should be understood that in some examples each helix of the phase shifting flow paths 107 may complete more than one full rotation between secondary inlet(s) 106 and secondary outlets 108 such that the helix pitch is not equal to the length of the device.

In some examples, n, C, and p may be configured such that the helical pathway length L (e.g., the phase shifting flow path 107) is configured to shift a phase of a sound wave propagating through a fluid at a target frequency by 180 degrees. For instance, the phase shifting flow path length L may be configured such that it is 1.5 times the length of a target frequency wavelength, which may induce a phase shift of 180 degrees, thus creating destructive interference as the fluid flowing through the phase shifting flow paths 107 combines with the fluid flowing through the primary flow path 103 at this frequency (e.g., downstream of outlets 104 and 108 of device 100).

In some examples, reflection can occur within the phase shifting flow paths 107 between outer surface 139 and inner surface 138 of the respective flow paths 107. There are shorter and longer overall paths (e.g., shorter and longer than 1.5 times the target frequency) that the fluid flowing through the phase shifting flow paths 107 can travel as the fluid reflects between outer surface 139 and inner surface 138. Accordingly, multiple sound waves propagating through the device at a range of frequencies (which may be secondary to a main target frequency) may be targeted for phase shifting using phase shifting flow paths 107. The range of frequencies may be a factor of L and the internal width 137 of the phase shifting flow paths 107 spanning between outer surface 139 and inner surface 138. Thus, due to reflections within the phase shifting flow paths, each phase shifting flow path 107 may be configured to shift a respective phase of each of a plurality of sound waves, each of the plurality of sound waves comprising one of a plurality of secondary target frequencies propagating through the second portion of the fluid such that each of the plurality of sound waves destructively interferes with a corresponding sound wave propagating through the first portion of the fluid flow. For instance, reflections within each flow path may result in shorter and longer paths traveled by the fluid/sound waves. A slightly longer or shorter path traveled within the phase shifting pathways due to these reflections will produce phase shifted sound waves (relative to sound waves in the primary flow path) within a range of frequencies that correspond to the different path lengths. Accordingly, sound waves at different frequencies (e.g., between 2-5K Hz) may be shifted out of phase by each respective phase shifting flow path relative to sound waves at the same frequency propagating within the primary flow path. The secondary target frequencies may also be within 2-5 KHz.

In some examples, housing 101 is configured to be attached to a fluid flow conduit such as a pipe, tube, vent, etc. For instance, housing 101 may include a lip 110 separated from housing 101 by a gap 111. The gap 111 may be configured to receive a fluid flow conduit such that the conduit is friction fit between lip 110 and housing 101. Fluid flowing through the attached conduit may be received into the primary and phase shifting flow paths via the primary and secondary inlets. The inner radius 131 of the primary flow path 103 may be smaller than that of the conduit it is connected to, thus necking the cross-section and increasing the velocity of air flowing through primary flow path 103. Thus, the size of the inner radius of the primary flow path may impact fluid flow velocity at the primary outlet 104 and, in turn, may impact fluid pressure/force at the primary outlet 104 and downstream of the device 100.

The phase shifting flow paths 107 of FIGS. 1A-1C include a rectangular cross-sectional profile within housing 101. The secondary inlets 106 of FIGS. 1A-1C include an arcuate profile, curved about the longitudinal axis 181 of the device 100 and located at an inlet surface 190. Secondary outlets 108 similarly include an arcuate profile, curved about the longitudinal axis 181 of the device 100 and located at an outlet surface 192. In some examples, other shapes may be utilized for the secondary inlets and/or phase shifting flow paths. For instance, a circular, oval, or triangular profile may be used for the phase shifting flow paths and/or secondary inlets/outlets.

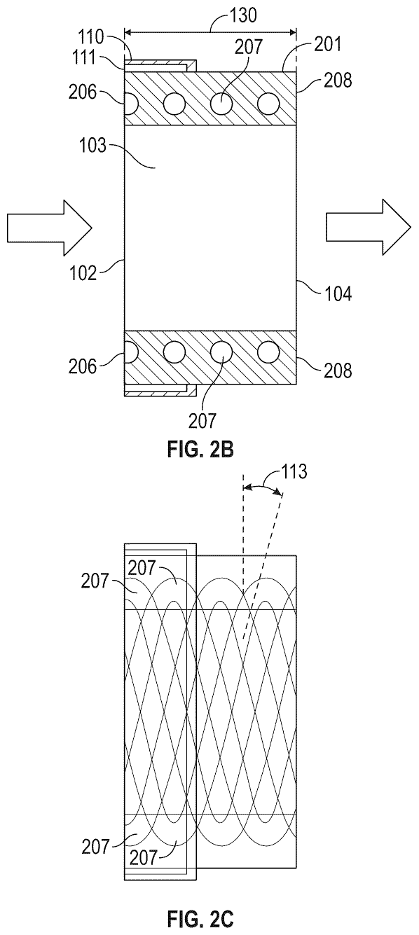

FIGS. 2A-2C illustrate an example of a noise reducing device 200 with circular phase shifting flow paths 207 extending between secondary inlets 206 and secondary outlets 208 positioned at inlet surface 190 and outlet surface 192, respectively. As shown in the isometric view of FIG. 2A, secondary inlets 206 include an oval profile positioned at inlet surface 190. Secondary outlets 208 include a similar oval profile positioned at outlet surface 192. The remaining features of noise reducing device 200 may be the same as those described above with reference to device 100. As shown in the cross-sectional view illustrated in FIG. 2B, primary flow path 103 may extend along the length of device 200 from primary inlet 102 to primary outlet 104. The phase shifting flow paths 207 and corresponding secondary inlets 206 may be positioned radially outward of the primary flow path 103 and primary inlet 102. The phase shifting flow paths 207 may include a helical portion that extends helically along the length of the housing 101 between a respective secondary inlet 206 and a respective secondary outlet 208. The helical portion of the phase shifting flow paths 207 may extend helically around the primary flow 102, helically coiled about a longitudinal axis 181 of device 200.

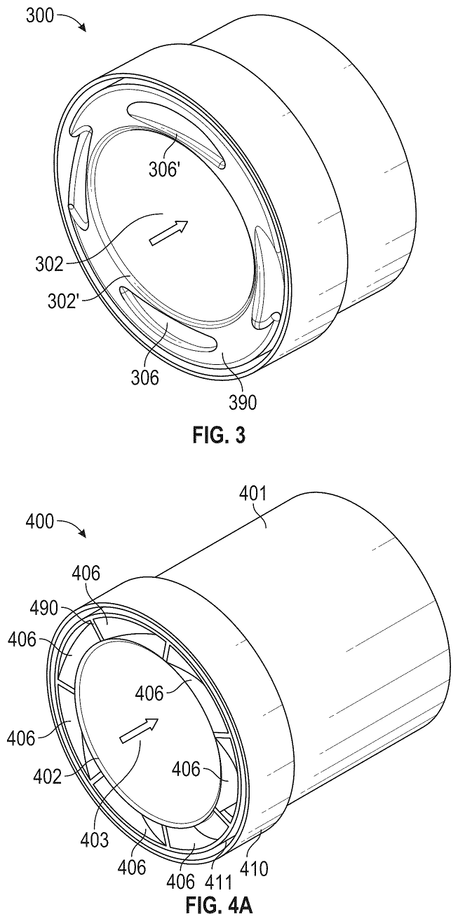

FIG. 3 illustrates an example of a noise reducing device 300 similar to device 200. The secondary inlets 306 leading to phase shifting flow paths (e.g., similar to phase shifting flow paths 207 of device 200) include a fillet (e.g., a rounded edge) or chamfer 306′ at an edge between each of the respective secondary inlets 306 and inlet surface 390. Primary inlet 302 leading to the primary flow path 303 also includes a fillet or chamfer 302′ at an edge between primary inlet 302 and primary flow path 303. The fillets 306′ and/or 302′ may increase the amount of incoming air directed through the phase shifting flow paths 307 and/or primary flow path 303, and thus may improve both the resulting destructive interference and the primary fluid flow.

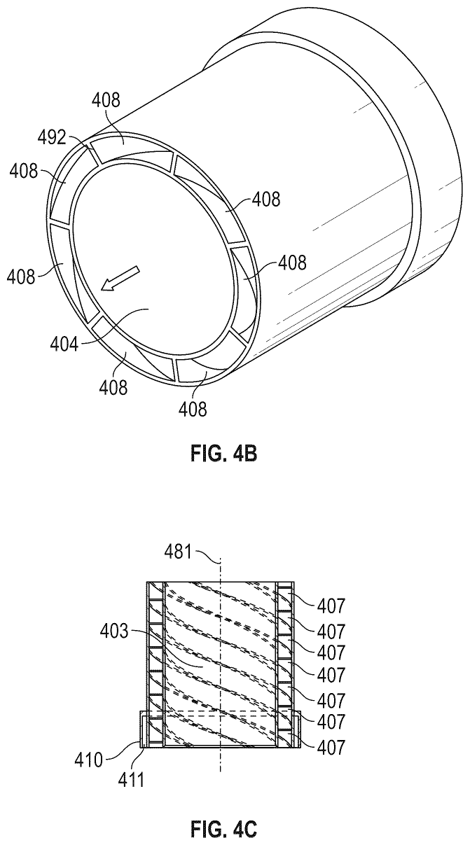

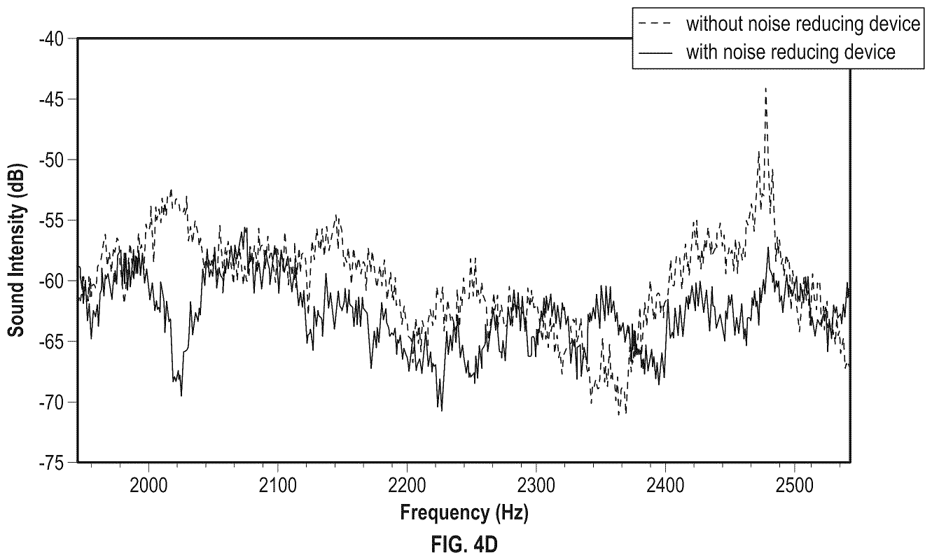

FIGS. 1A-3 illustrate an example of a noise reducing device with four phase shifting flow paths. Some examples may include additional or fewer phase shifting flow paths. For instance, FIGS. 4A-4C illustrate an example of a noise reducing device 400 with seven phase shifting flow paths 407. The additional phase shifting flow paths (relative to device 100) may enable greater destructive interference and noise canceling (e.g., relative to device 100) due to the greater amount of fluid flow entering the phase shifting flow paths 407.

FIG. 4A illustrates an isometric view of an inlet end of an example noise reducing device 400. FIG. 4B illustrates an isometric view of an outlet end of noise reducing device 400. As shown, the device 400 includes a housing 401. Housing 401 includes a primary fluid flow inlet 402 leading to a primary flow path 403, which may be a hollow tube, duct, or other conduit extending along the length of device 400 from primary inlet 402. Device 400 also includes a plurality of secondary inlets 406 that lead to respective phase shifting flow paths 407 within the housing 401 (as shown in FIG. 4C). As shown, device 400 includes seven secondary inlets 406 leading to seven respective phase shifting flow paths 407. Primary flow path outlet 404 and a plurality of secondary outlets 408 are positioned at the outlet end of device 400. As shown, the inlet and outlet geometry for each of the respective phase shifting flow paths 407 may be identical. Similarly, the inlet and outlet geometries for the primary flow path 403 may be identical.

Secondary inlets 406 may be positioned at the same longitudinal location along device 400 as primary inlet 402, and secondary outlets 408 may be positioned at the same longitudinal location along device 400 as primary outlet 404. Secondary inlets 406 and primary inlet 402 may be positioned flush with the inlet surface 490. Secondary outlets 408 and primary outlet 404 may be positioned flush with the outlet surface 492. In some examples, secondary inlets 406 may be positioned at a different longitudinal location along device 400 than primary inlet 402, and/or secondary outlets 408 may be positioned at a different longitudinal location along device 400 than primary outlet 404. In some examples, one or more of secondary inlets 406 are positioned at a different longitudinal location from one or more other secondary inlets 406. In some examples, one or more of secondary outlets 408 are positioned at a different longitudinal location from one or more other secondary outlets 408.

FIG. 4C illustrates a section view of exemplary noise reducing device 400 that provides a detailed depiction of the internal structure of the primary flow path 403 and phase shifting flow paths 407. Primary flow path 403 extends along the length of device 400 from primary inlet 402 to primary outlet 404. The phase shifting flow paths 407 and corresponding secondary inlets 406 are positioned radially outward of the primary flow path 403 and inlet 402. The phase shifting flow paths 407 include a helical portion that extends helically along the length of the housing 401 between the secondary inlets 406 and secondary outlets 408. The helical portion of the phase shifting flow paths 407 may extend helically around the primary flow path 402, helically coiled about a longitudinal axis 481 of device 400 between the inlet surface 490 and outlet surface 492. Like housing 101 of device 100, housing 401 may be configured to be attached to a fluid flow conduit such as a pipe, tube, vent, etc. For instance, housing 401 may include a lip 410 separated from housing 401 by a gap 411. The gap 411 may be configured to receive a fluid flow conduit such that the conduit is friction fit between lip 410 and housing 401.

A fluid flowing through a conduit connected to device 400 may be received into the primary flow path 403 and the phase shifting flow paths 407 via primary inlet 402 and secondary inlets 406, respectively. A first portion of the fluid flow may be received into primary flow path 403 via primary inlet 402. The first portion may propagate forward within the primary flow path 403 of housing 401 toward primary outlet 404. The inner radius of primary flow path 403 may be smaller than that of the conduit it is connected to, thus necking the cross-section and increasing the velocity of the first portion of the fluid flowing through the primary flow path 403. A second portion of the fluid may flow into the phase shifting flow paths 407 via secondary inlets 406. The second portion may propagate helically along each phase shifting flow path 407 toward secondary outlets 408. At least a first sound wave may be produced by the first portion of the fluid flowing through the primary flow path 403 and may propagate within the first portion of the fluid. At least a second sound wave may be produced by the second portion of the fluid flowing through the phase shifting flow paths 407 and may propagate within the second portion of the fluid. The phase shifting flow paths 407 may be configured such that the second sound wave is out of phase (e.g., phase shifted by approximately 180 degrees) from the first sound wave.

As the respective portions of the fluid flow exit device 400 they may combine with one another. Due to the relative positioning of the secondary outlets 408 (radially outward of primary outlet 404), the second portion of the fluid flow, including one or more phase shifted sound waves, may surround the first portion of the fluid flow downstream of device 400. The phase shifted sound waves may destructively interfere with sound waves in the first portion of the fluid flow, thus reducing sound at the target frequencies.

FIG. 4D illustrates a graph providing a comparison of decibel levels at different frequencies within the 2-3 kHz range for both blower device (e.g., a leaf blower) having a standard conduit compared to the same blower device having an exemplary version of the noise reducing device attached to the conduit. In order to measure the effectiveness of the exemplary noise reducing device, a blower was recorded for 30 seconds with the noise reducing device and then with a conventional blower conduit (a concentrator). A fast Fourier transform (FFT) of the sound profile was plotted to analyze the blower's frequency response with the noise reducing device. The results are shown for the exemplary device of FIGS. 4A-4C in FIG. 4D. As anticipated, the largest reduction in noise level was between 2 and 2.1 kHz. There were other significant reductions in key frequencies in the 2-2.5 kHz range due to alternate path lengths of air traveling through the phase shifting flow paths 407 (e.g., due to reflections). The overall average reduction in noise level between the 1-5 kHz frequency range was 3.5 decibels (dB). Moreover, while the overall sound level was reduced, by lowering the intensity of the peak frequencies in the 2-4 kHz range, the sound quality of the blower as perceived by human hearing was also improved.

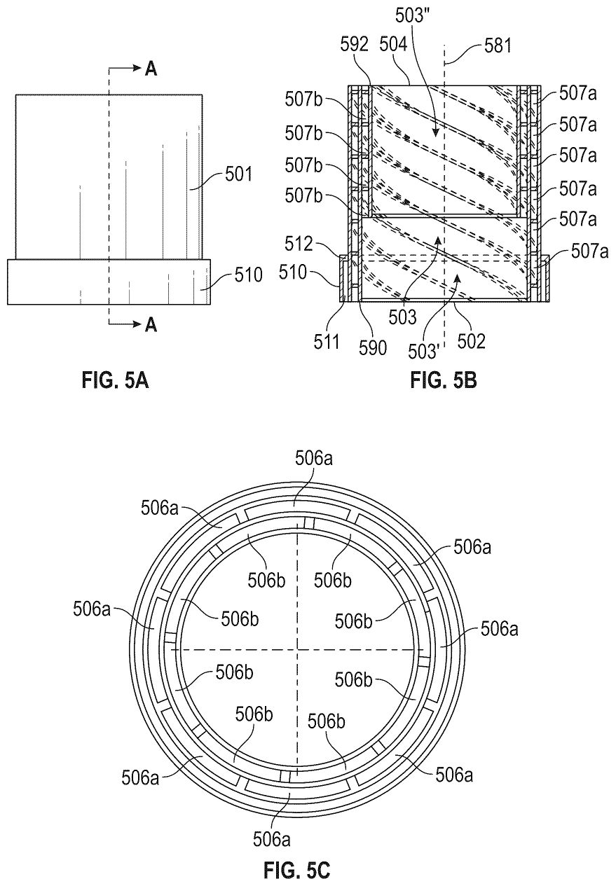

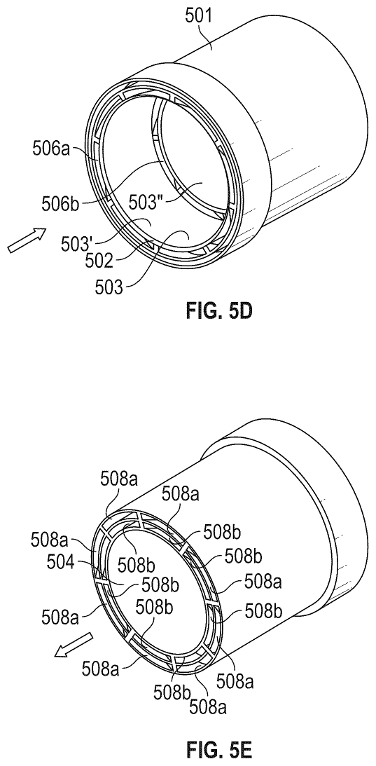

The exemplary noise reducing devices illustrated in FIGS. 1A-4C each included a single layer of phase shifting flow paths. In some examples, multiple layers of phase shifting flow paths may be stacked. The layers may be positioned at different respective radial locations of the noise reducing device housing. FIGS. 5A-5E illustrate an example of noise reducing device 500 that includes multiple layers of phase shifting flow paths. FIG. 5A illustrates a top view of device 500 that includes a housing 501 and a lip 510 configured to attach device 500 to a fluid flow conduit. FIG. 5B illustrates a section view of device 500 that depicts the internal structure of the housing 501, including a first layer of phase shifting flow paths 507a and a second layer of phase shifting flow paths 507b. Stacking multiple layers of phase shifting flow paths may enable device 500 to phase shift sound waves at multiple different target frequencies and/or frequency ranges (e.g., due to reflections within the phase shifting pathways).

A primary flow path 503 extends along the length of device 500 from primary inlet 502 to primary outlet 504. The first layer of phase shifting flow paths 507a may be positioned radially outward of primary flow path 503. Each respective phase shifting flow path 507a of the first layer may extend from a respective secondary inlet 506a. The secondary inlets 506a of the first layer of phase shifting flow paths 507a may also be positioned radially outward of primary flow path 503 and primary inlet 502 (as shown in the section view of FIG. 5B and the front view of FIG. 5C). The secondary inlets 506a of the first layer of phase shifting flow paths 507a are positioned at a first location along longitudinal axis 581 of device 500. The primary inlet 502 may also be positioned at the first location along longitudinal axis 581 of device 500. The first location may be flush with an inlet surface 590 at the front (upstream) end of device 500, recessed from inlet surface 590 (e.g., downstream of the inlet surface 590), or may be positioned upstream of inlet surface 590.

The second layer of phase shifting flow paths 507b may be positioned radially inward of the first layer of phase shifting flow paths 507a. A diameter of the first portion 503′ of primary flow path 503 may be larger than a diameter of the second portion 503″. Secondary inlets 506b for the second layer of phase shifting flow paths may be positioned at a second location along longitudinal axis 581 of device 500. The second location may be downstream from the first location. The second location at which secondary inlets 506b are positioned may be located between inlet surface 590 and outlet surface 592.

Device 500 may be configured to be attached to a fluid flow conduit. Device 500 may include a lip 510 separated from housing 501 by a gap 511. The gap 511 may be configured to receive a fluid flow conduit such that the conduit is friction fit between lip 510 and housing 501. In some examples, the lip 510 may be an L-shaped lip that extends outward from an outer surface of housing 510 and then turns to extend forward along the direction of the longitudinal axis 581 toward inlet surface 590. In some examples, lip 510 includes an annular ring portion that surrounds at least a portion of housing 501 and is connected to housing 501 by a flange 512. FIGS. 5D and 5E illustrate front and rear isometric views of device 500 that clearly depict the relative positioning of the inlets and outlets to the primary flow path 503 and phase shifting flow paths 507a and 507b.

Fluid flowing through an attached conduit may be received into the primary flow path 503 and phase shifting flow paths 507a and 507b via the primary inlet 502 and secondary inlets 506a and 506b, respectively. A first portion of a fluid flow may be received by primary flow path 503 via primary inlet 502 into the first portion 503′ of primary flow path 503. The first portion may propagate forward toward primary outlet 504. The inner radius of the first portion 503′ of primary flow path 503 may be smaller than that of the conduit it is connected to, thus necking the cross-section and increasing the velocity of air flowing through the primary flow path 503. A second portion of the fluid may flow into the first layer of phase shifting flow paths 507a via the respective secondary inlets 506a. The second portion may propagate helically along each phase shifting flow path 507a toward secondary outlets 508a. Downstream of the primary inlet 502, a third portion of the fluid may break from the first portion and flow into the second layer of phase shifting flow paths 507b via the respective secondary inlets 506b. The third portion may propagate helically along each of phase shifting flow paths 507b toward secondary outlets 508b. The remainder of the first portion of the fluid flow may enter the second portion 503″ of the primary flow path and continue propagating forward toward primary outlet 504. The inner radius of the second portion 503″ of primary flow path 503 may in turn be smaller than the inner radius of the first portion 503′, thus further increasing the velocity of air flowing through the primary flow path 503 as the flow transitions from the first portion 503′ to second portion 503″.

As the second and third portions of the fluid flow propagate within respective phase shifting flow paths 507a and 507b, sound waves may be produced that are 180 degrees out of phase with sound waves propagating within the first portion of the fluid through the first portion 503′ and second portion 503″ of the primary flow path. For instance, at least one sound wave may be produced by the second portion of the fluid flowing through the phase shifting flow paths 507a that is out of phase with a corresponding sound wave propagating within the first portion of the fluid flowing through the first portion of primary flow path 503′. Another sound wave may be produced by the third portion of the fluid flowing through the phase shifting flow paths 507b that is out of phase with a corresponding sound wave propagating within the portion of the fluid flowing through the second portion of primary flow path 503″. The respective phase shifting flow paths 507a and 507b may be configured to produce sound waves at specific target frequencies that are out of phase with sound waves at the same frequencies within the respective portions of primary flow path 503′ and 503″. In some examples, the first layer of phase shifting flow paths 507a may be configured to phase shift sound waves including a first target frequency/frequency range and the second layer of phase shifting flow paths 507b may be configured to phase shift sound waves including a second target frequency/frequency range, as described further below.

As described above, the frequency (and/or range of frequencies due to reflection within the phase shifting flow paths) targeted by the phase shifting flow paths 507a and 507b are a function of the overall length of the phase shifting pathway. In examples where the phase shifting flow paths include helical portions, the overall length is determined using equation (1) above based on the number of helical revolutions, the mean circumference of the helical pathway, and the pitch of the helix. A phase shifting flow path configured to be 1.5 times the length of a wavelength of a sound wave at a target frequency may phase shift the sound wave by 180 degrees. In the example device of FIGS. 5A-5C, the first layer of phase shifting flow paths 507a is longer than the second layer of flow shifting pathways 507b and thus configured to phase shift sound waves having longer wavelengths (and lower frequencies) than the second layer of phase shifting flow paths 507b. Both layers of phase shifting flow paths 507a and 507b may be configured to produce phase shifted sound waves targeting a range of frequencies within the audible frequency spectrum (e.g., between 20 Hz and 20 kHz). In some examples, the at least one target frequency is between 2 kHz and 5 kHz (the most unpleasant frequencies to the human ear). Reflections within each of the pathways may result in shorter and longer paths traveled from inlets 506a and 506b to outlets 508a and 508b. Accordingly, in some examples, phase shifting flow path 507a is configured to phase shift sound waves having a first range of frequencies (e.g., a first range within 2 kHz and 5 kHz) while phase shifting flow path 507a is configured to phase shift sound waves having a second range of frequencies (e.g., a second range within 2 kHz and 5 kHz).

As the respective portions of the fluid flow exit device 500, they may combine with one another. Due to the relative positioning of the secondary outlets 508a and 508b, the second and third portions of the fluid flow, including phase shifted sound waves, may surround the first portion of the fluid flow downstream of device 500. The phase shifted sound waves may destructively interfere with sound waves in the first portion of the fluid flow, thus reducing sound at the target frequencies.

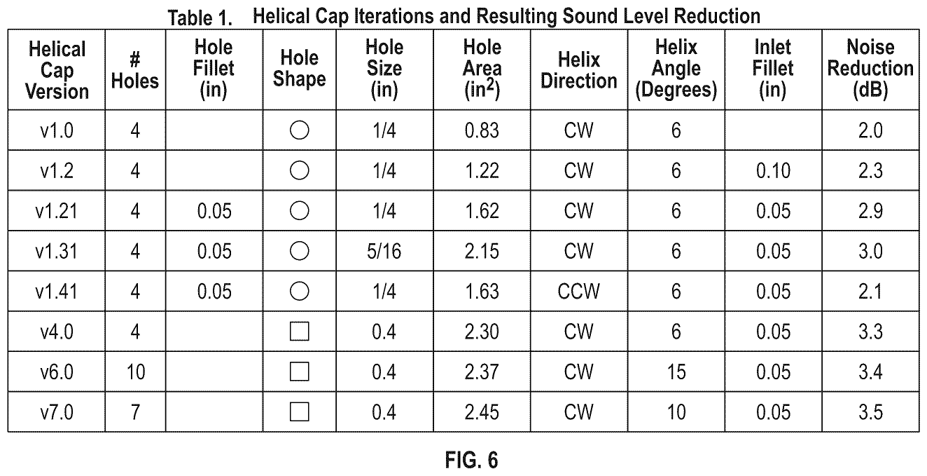

Adjusting various aspects of the geometry of the noise reducing devices described herein can impact performance, both in terms of sound reduction and in terms of blow force (e.g., the force the fluid exerts downstream of the device outlet). While the noise reducing devices herein are described with reference to specific examples having particular configurations of primary and phase shifting flow paths, it should be understood that a number of modifications to the designs described herein fall within this disclosure. For instance, FIG. 6 illustrates a table of design alternatives for different aspects of the noise reducing devices described herein, and a corresponding impact on noise reduction for the different design alternatives. As shown, sound reduction (e.g., noise canceling performance) may increase with greater fluid flow through the phase shifting flow paths. Increasing the cross-sectional area for the phase shifting flow paths, including fillets at the pathway inlets, and/or use of rectangular holes may increase flow through the phase shifting flow paths and thus provide greater noise reduction. The exemplary noise reducing devices shown in FIG. 6 were 3D printed with polylactic acid (PLA) filament. In some examples, any of the noise reducing devices described herein may be 3D printed using PLA filament, acrylonitrile butadiene styrene (ABS), acrylonitrile styrene acrylate (ASA), and/or polypropylene. In some examples, the noise reducing devices described herein may be manufactured using plastics, metals, and/or composite materials. In some examples, the noise reducing devices may be 3D printed, cast, molded, machined, and/or manufactured according to any other methods capable of forming the devices described herein.

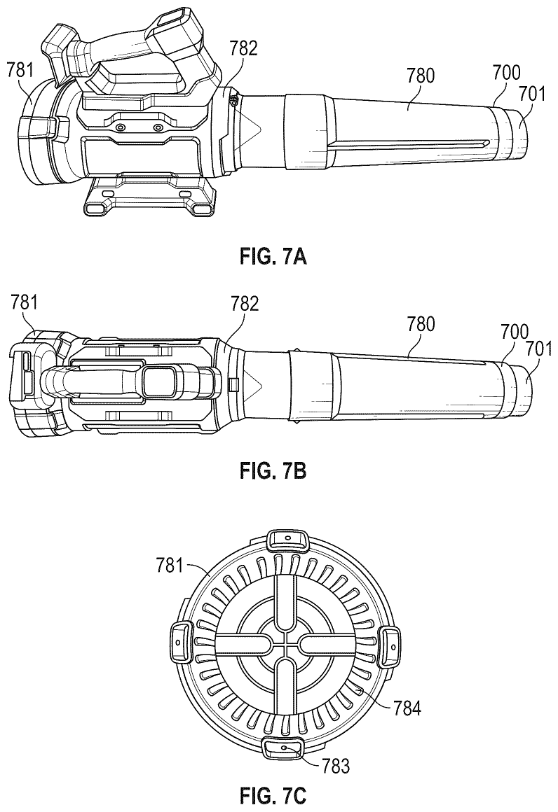

As described throughout, the noise reducing devices described herein may be configured to be attached to a fluid flow conduit. In some examples, the conduit may be connected to a fluid source, such as a blower (e.g., a leaf blower, hair dryer), or a vacuum. FIGS. 7A and 7B illustrate an exemplary noise reducing device 700 with a housing 701 connected to a conduit 780 of a blower 782. Blower 782 may induce a fluid flow into conduit 780 that is received by noise reducing device 700. A first portion of the fluid may flow through a primary flow path within the housing 701 extending from a primary inlet to a primary outlet. A second portion may flow through at least one phase shifting flow path within the housing 701 extending from at least one secondary inlet to at least one secondary outlet. At least a first sound wave may be produced by the first portion of the fluid flowing through the primary flow path and propagate within the first portion of the fluid. At least a second sound wave may be produced by the second portion of the fluid flowing through the phase shifting flow paths. The phase shifting flow paths may be configured such that the second sound wave is out of phase (e.g., the phase is shifted by approximately 180 degrees) from the first sound wave.

Increasing the angle of the helical portion of the phase shifting flow paths may minimize the impact of the noise reducing device on blow force fluid provided by blower 782. Further, increasing the radius of the primary flow path (thus letting more blower air from the nozzle travel through the primary flow path of device 700), can mitigate the impact of device 700 on blow force.

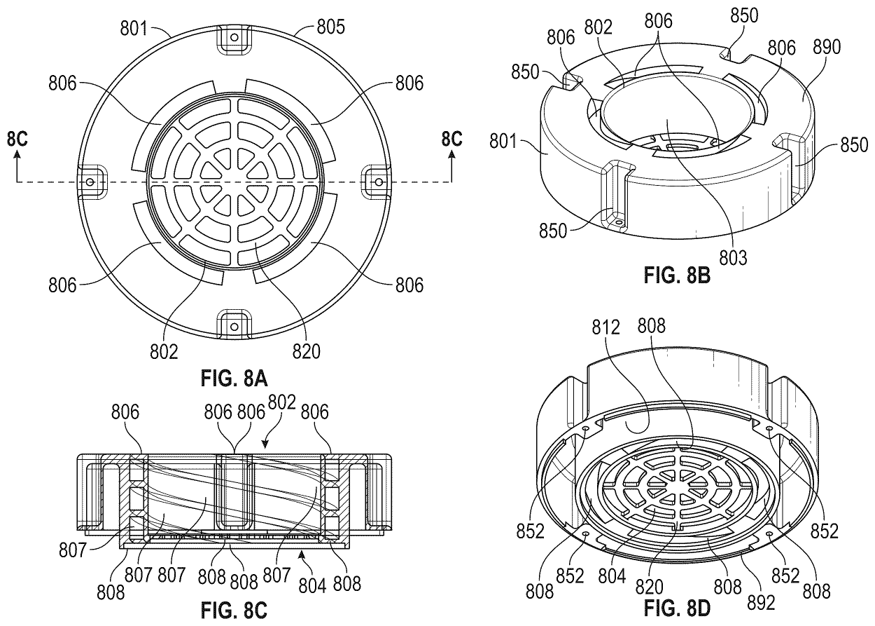

The example noise reducing devices described above are configured to be attached to an outlet end of a conduit such as conduit 780 of FIG. 7. In some examples, exemplary noise reducing devices may be configured to be connected to a conduit at locations other than the outlet end, for instance, at the inlet end of a conduit such as conduit 780. FIGS. 8A-8D illustrate an example of a noise reducing device 800 configured to be connected to an intake of a blower device. FIG. 8A illustrates a front view of example noise reducing device 800. Noise reducing device 800 includes a housing 801, a primary fluid flow path inlet 802, and a plurality of phase shifting flow path inlets 806. As shown in FIG. 8B, the primary inlet 802 and each of the phase shifting flow path inlets 806 are positioned at an inlet surface 890 of device 800. As shown in FIG. 8C, the phase shifting flow path inlets 806 lead to a plurality of phase shifting flow paths 807 positioned radially outward of the primary flow path 803 that extends from primary inlet 802 to a primary outlet 804 located at outlet surface 892. A screen 820 is positioned at primary outlet 804 and configured to filter debris from the fluid flow exiting the primary flow path 803 via primary outlet 804.

The phase shifting flow paths 807 extend helically around primary flow path 803 from the secondary inlets 806 to secondary outlets 808 positioned at the outlet surface 892, as shown in FIG. 8C. As described throughout, a portion of a fluid flow may be received via each of the secondary inlets 806 and may propagate along the respective phase shifting flow paths 807 toward a respective secondary outlet 808. A sound wave may be produced by the portion of the fluid flowing through each of the respective phase shifting flow paths 807. Another sound wave may be produced by a portion of fluid flowing through the primary flow path 803. The sound wave produced by the portion of the fluid flowing through each of the respective phase shifting flow paths 807 may be phase shifted such that it is out of phase approximately 180 degrees relative to the sound wave produced by the portion of fluid flowing through the primary flow path 803. The phase shift may cause the sound waves to destructively interfere with one another downstream of the respective outlets 808 and 804.

Housing 801 may be configured such that it can be mounted to an intake of a blower device (e.g., intake 781 of FIGS. 7A-7C). Device 800 may include one or more slots 850 configured to mount device 800 to intake 781. As shown in FIG. 8D, the slots 850 include an aperture 852 that may be configured to receive a fastener (e.g., bolt) for mechanically fastening device 800 to intake 781. For instance, device 800 may be configured such that the aperture 852 aligns with respective apertures 783 of intake 781. In some examples, an annular gap 812 is formed between an outer diameter 805 of housing 801 and an outer diameter of primary flow path 803. The annular gap 812 may be configured to receive a surface second flow conduit (e.g., surface 784 of intake 781) into which the fluid exiting primary flow path 803 and secondary flow paths 807 is directed. It should be understood that various modifications to device 800 (or any other noise reducing devices described herein) are within the scope of this disclosure. For instance, while the exemplary devices that are described herein are configured to be mounted to specific portions of a blower apparatus (e.g., an intake of a blower device or outlet of a blower tube), the techniques and devices described herein may be configured to be mounted to any fluid flow intake, outlet, conduit, or otherwise mounted along a flow path. The devices described herein may be configured be removably mounted/attached, permanently affixed or connected to, integral to or otherwise positioned along such flow paths to create destructive interference and reduce noise levels as described herein.

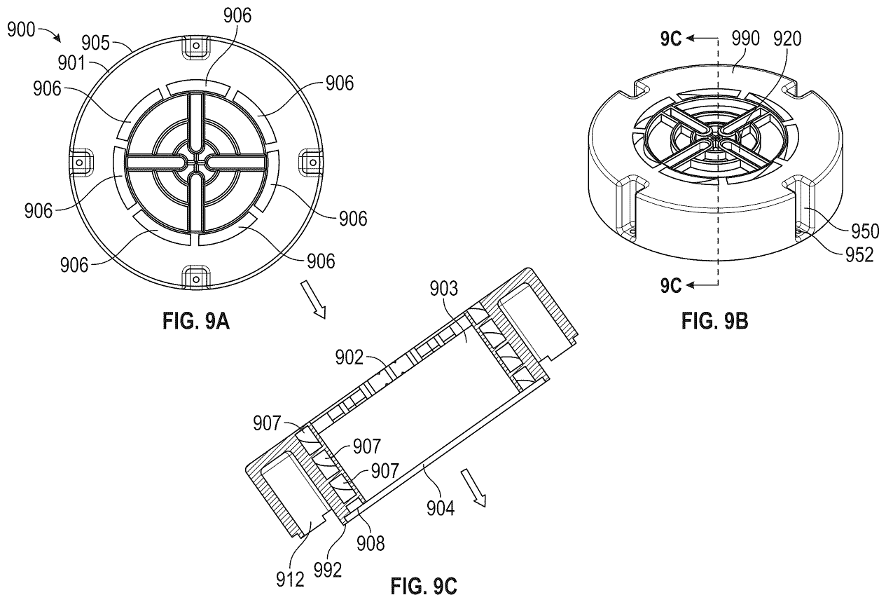

FIGS. 9A-9C illustrate another example of a noise reducing device 900 configured to be attached to an intake of a blower device. As depicted in the illustration of FIGS. 9A-9C, device 900 includes additional (seven total) secondary inlets 906 relative to device 800, leading to seven phase shifting flow paths 907. FIG. 9A illustrates a front view of exemplary noise reducing device 900. Noise reducing device 900 includes a housing 901, a primary flow path inlet 902 (labeled in FIG. 9C), and a plurality of secondary, phase shifting flow path inlets 906. As shown in FIG. 9B, the primary inlet 902 and each of the phase shifting flow path inlets 906 are positioned at an inlet surface 990 of device 900. As shown in FIG. 9C, the phase shifting flow path inlets 906 lead to a plurality of phase shifting flow paths 907 positioned radially outward of the primary flow path 903 that extends from primary inlet 902 to a primary outlet 904 located at outlet surface 992. A screen 920 (e.g., a filter or grill) is positioned at primary inlet 902 and configured to filter debris from the fluid flow entering the primary flow path 903 via primary inlet 902. Screen 920 of device 900 is configured to mimic the geometry of a grill 785 provided on intake 781.

The phase shifting flow paths 907 extend helically around primary flow path 903 from the secondary inlets 906 to secondary outlets 908 positioned at the outlet surface 992, as shown in FIG. 9C. As described throughout, a portion of a fluid flow may be received via each of the secondary inlets 906 and may propagate along the respective phase shifting flow paths toward a respective secondary outlet. A sound wave may be produced by the portion of the fluid flowing through each of the respective phase shifting flow paths 907. Another sound wave may be produced by a portion of fluid flowing through the primary flow path 903. The sound wave produced by the portion of the fluid flowing through each of the respective phase shifting flow paths 907 may be phase shifted such that it is out of phase approximately 180 degrees relative to the sound wave produced by a portion of fluid flowing through the primary flow path 903. The phase shift may cause the sound waves to destructively interfere with one another downstream of the respective outlets 908 and 904.

Housing 901 may be configured such that it can be mounted to an intake of a blower device (e.g., intake 781 of FIGS. 7A-7C). Device 900 may include one or more slots 950 configured to mount device 900 to intake 781. As shown in FIG. 9B, the slots 950 include an aperture 952 that may be configured to receive a fastener (e.g., bolt) for mechanically fastening device 900 to intake 781. For instance, device 900 may be configured such that the aperture 952 aligns with respective apertures 783 of intake 781. In some examples, an annular gap 912 is formed in housing 901 between an outer diameter 905 of housing 901 and an outer diameter of primary flow path 903. The annular gap 912 may be configured to receive a surface second flow conduit (e.g., surface 784 of intake 781) into which the fluid exiting primary flow path 903 and secondary flow paths 907 is directed.

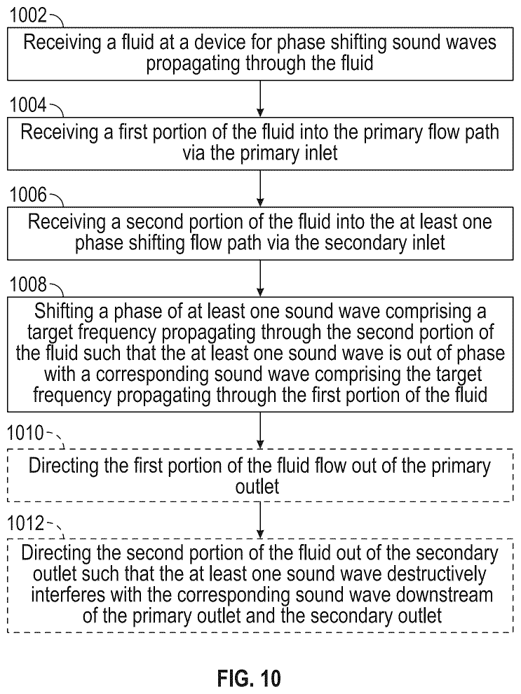

FIG. 10 illustrates an exemplary method for shifting a phase of the at least one sound wave propagating within a fluid. At block 1002, the method includes receiving a fluid at a device for phase shifting sound waves propagating through the fluid. The device may include a housing, a primary flow path extending from a primary inlet to a primary outlet, and at least one phase shifting flow path comprising a secondary inlet and a secondary outlet. The fluid may be a gas (e.g., air). The fluid may be at a temperature between 0 Celsius and 100 Celsius. The fluid may be at a temperature between 15 Celsius and 30 Celsius. The fluid may be received from a blower device such as a leaf blower, a fan, or other blower device. In some examples, the fluid may be drawn into the noise reducing device by a vacuum device.

At block 1004, the method includes receiving a first portion of the fluid into the primary flow path via the primary inlet of the noise reducing device. The primary flow path may be a conduit/duct extending from an inlet end to an outlet end of the housing. The primary flow path may be cylindrical, rectangular, or any other geometry. The primary flow path may include a screen at an inlet end, outlet end, and/or within the primary flow path, and may include any of the features described with reference to the primary flow path of the noise reducing devices described herein.

At block 1006, the method includes receiving a second portion of the fluid into the at least one phase shifting flow path via the secondary inlet. The at least one phase shifting flow path may extend from a respective secondary inlet to a respective secondary outlet of the housing of the noise reducing device and may include any of the features described herein. For instance, the at least one phase shifting flow path may include a helical portion that extends along at least a portion of the housing between the at least one secondary inlet and the at least one secondary outlet. The helical portion of the at least one phase shifting flow path may extend helically around the primary flow path. The at least one phase shifting flow path may be positioned radially outward of the primary flow path on the device. A length of the at least one phase shifting flow path is greater than a length of the primary flow path. The at least one phase shifting flow path may be configured to shift the phase of a first sound wave such that it is 180 degrees out of phase relative to a second sound wave propagating within the first portion of the fluid in the primary flow path.

At block 1008, the method includes shifting a phase of the at least one sound wave comprising a target frequency propagating through the second portion of the fluid such that the at least one sound wave is out of phase with a corresponding sound wave comprising the target frequency propagating through the first portion of the fluid. As fluid flows through both the primary flow path and the phase shifting flow path(s), one or more sound waves may be produced. The phase shifting flow path(s) may be configured such that one or more sound waves produced as fluid flows through the phase shifting flow path(s) are out of phase with one or more sound waves produced at the same frequency (e.g., a target frequency) as fluid flows through the primary flow path.

The target frequency may be between 1.5 kHz and 5.5 kHz. The target frequency may be between 2 kHz and 5 kHz. The target frequency may be at least 2 kHz, at least 3 kHz, at least 4 kHz, and/or at least 5 kHz. The target frequency may be at most 2 kHz, at most 3 kHz, at most 4 kHz, and/or at most 5 kHz. A length of the at least one phase shifting flow path may be greater than a wavelength of the sound wave comprising the target frequency propagating through the first portion of the fluid, which may induce a phase shift as sound waves at the respective target frequency in the second portion of the fluid must travel a greater distance within the device than sound waves in the first portion of the fluid. In some examples, the at least one phase shifting flow path may be configured to shift a respective phase of each of a plurality of sound waves, each of the plurality of sound waves including one of a plurality of secondary target frequencies propagating through the second portion of the fluid such that each of the plurality of sound waves destructively interferes with a corresponding sound wave propagating through the first portion of the fluid flow. Sound waves at more than one frequency may be phase shifted due to reflections within the phase shifting flow paths that result in shorter and longer pathways traveled within each phase shifting flow path.

At block 1010, the method may include directing the first portion out of the primary outlet of the noise reducing device. At block 1012, the method may include directing the second portion of the fluid out of the secondary outlet such that the at least one sound wave that was phase shifted by the noise reducing device destructively interferes with the corresponding sound wave (that traveled through the primary flow path) downstream of the primary outlet and the secondary outlet. The primary outlet and the secondary outlet may be located on a rear surface of the device and configured such that the first portion of the fluid and the second portion of the fluid combine downstream of the primary outlet and the secondary outlet.

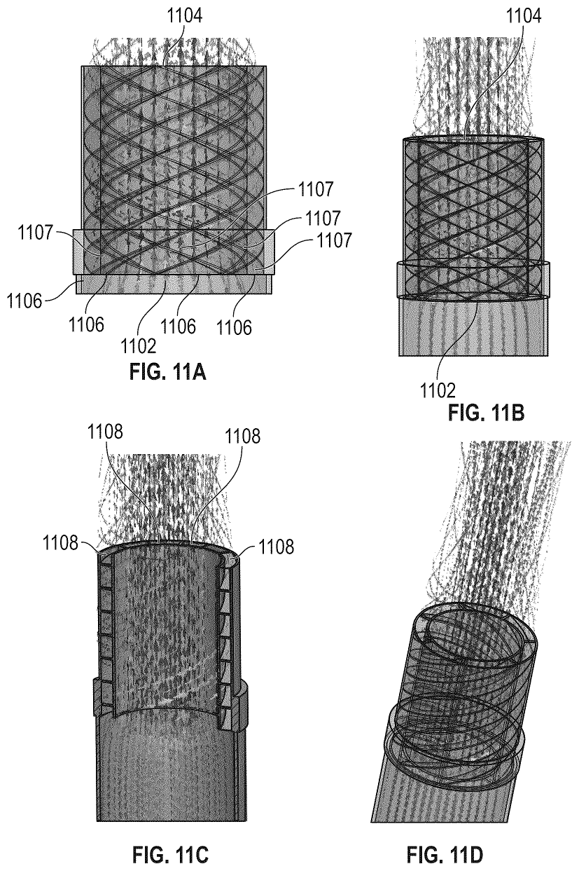

FIGS. 11A-11D illustrate a fluid flow simulation of air flowing through an example noise reducing device 1100 that includes a primary flow path 1103 and a plurality of phase shifting flow paths 1107. Device 1100 is identical to device 400 described above, but the simulated flow illustrated is representative of any of the devices described herein. As shown, a first portion of fluid is received via a primary inlet 1102 of device 1100 and propagates forward through the device 1100 toward primary outlet 1104. The first portion of fluid increases in velocity upon entering the device as illustrated by the transition in color from green/blue to red. A second portion of the fluid is received via respective secondary inlets 1106 corresponding to respective phase shifting flow paths 1107. The second portion of the fluid propagates along the helical phase shifting flow paths toward secondary outlets 1108. The first and second portions of the fluid exit device 1100 via the primary outlet 1104 and the secondary outlets 1108, respectively, and combine with one another. As shown, the second portion of the fluid flow leaving the phase shifting flow paths may partially surround and/or mix with the first portion of the fluid flow exiting the primary flow path.

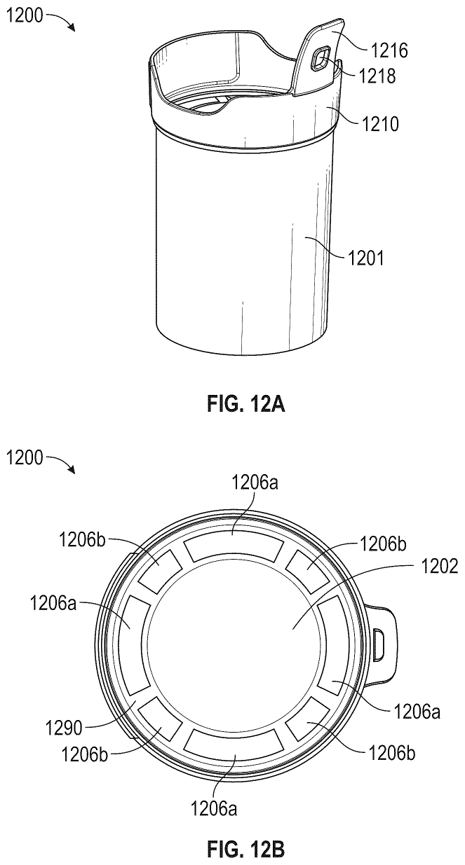

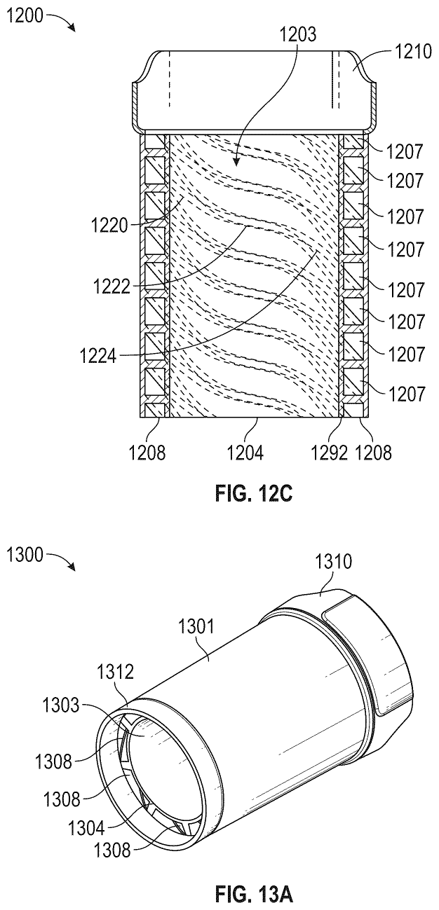

As described throughout, the phase shifting pathways may be helically shaped pathways. In some examples, the pitch and/or helix angle of the helical phase shifting pathways may be constant along the length of the devices described herein. In some examples, the pitch and/or helix angle of the helical phase shifting pathways may vary. A helical phase shifting pathway may extend along a first portion of any of the noise reducing devices described herein at one pitch and/or helix angle and extend along a second portion of the noise reducing device at a different pitch and/or helix angle. In some examples, the pitch and/or helix angle of a helical phase shifting pathway may vary at specific radial points along the length of any of the noise reducing devices described herein. In some examples, one or more phase shifting flow paths may extend along the length of any of the noise reducing devices described herein at a first pitch and/or helix angle, and one or more other phase shifting flow paths may extend along the same device at a different pitch and/or helix angle. FIGS. 12A-12C illustrate an exemplary noise reducing device 1200 in which the pitch and helix angle of a plurality of helical phase shifting pathways varies at a plurality of different locations along the length of device 1200.

FIG. 12A illustrates an exemplary noise reducing device 1200. As shown, device 1200 includes a housing 1201. Device 1200 further includes a lip 1210 configured to be friction fit to a blower tube and a clip 1216 extending from the lip 1210. The clip 1216 may be configured to enable a user to easily install and remove the device 1200 from a blower tube. For instance, as shown, the clip 1216 includes an aperture 1218 which may be configured such that a protrusion on a blower tube can be inserted into the aperture, providing a secure attachment to the blower tube. FIG. 12B illustrates a front view of the noise reducing device 1200. As shown, device 1200 includes a primary flow path inlet 1202 and a plurality of phase shifting flow path inlets 1206a and 1206b positioned at an inlet surface 1290 of device 1200. The phase shifting flow path inlets 1206a may be a different size and/or shape than phase shifting flow path inlets 1206b. This may result in a different amount of fluid flow entering inlets 1206a than the amount entering 1206b.

FIG. 12C illustrates a plurality of phase shifting flow paths 1207 extending helically along the length of device 1200 around a primary flow path 1203 between the phase shifting flow path inlets 1206a and 1206b and phase shifting flow path outlets 1208 positioned at outlet surface 1292 of device 1200. The primary flow path 1203 extends from primary inlet 1202 to primary outlet 1204, also positioned at outlet surface 1292. The phase shifting flow paths 1207 extend helically along the length of device 1200 at varying pitches and helix angles. For instance, in the example depicted in FIG. 12C, each of phase shifting flow paths 1207 extends at a first helix angle (and thus first pitch) 1220 along a first portion of device 1200, a second helix angle (and thus second pitch) 1222 along a second portion of device 1200, and a third helix angle (and thus third pitch) 1224 along a third portion of device 1200. As shown, the pitch of each of phase shifting flow paths 1207 transitions between the different pitch and helix angles at different points along the length of the device 1200.

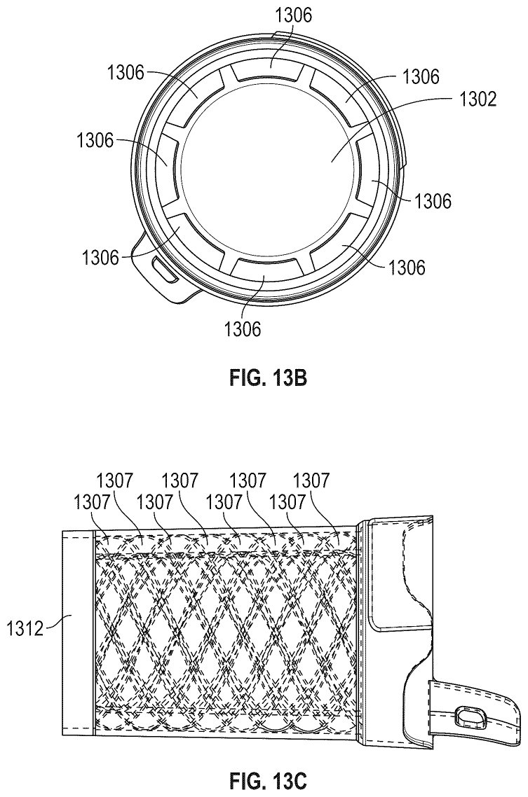

FIG. 13A illustrates an exemplary noise reducing device 1300. Device 1300 includes an outlet wall 1312 configured to concentrate a fluid flow exiting a primary outlet 1303 and a fluid flow exiting the plurality of secondary phase shifting outlets 1308 together. The outlet wall 1312 may be an annular/cylindrical outlet wall and may provide for enhanced blow force relative to a noise reducing device without an annular outlet wall positioned downstream of the outlets 1304 and 1308. Annular outlet wall 1312 may be positioned downstream of the primary outlet 1304 and secondary phase shifting flow path outlets 1308. In some examples, the annular outlet wall 1312 is integral to device 1300. In some examples, the annular outlet wall 1312 is removably attached to device 1300. In some examples, annular outlet wall 1312 extends downstream of the primary outlet 1304 and secondary outlets 1308 at least 0.25 inches. In some examples, annular outlet wall 1312 extends downstream of the primary outlet 1304 and secondary outlets 1308 at least 0.5 inches, at least 0.75 inches, at least 1 inch, at least 1.25 inches, at least 1.5 inches, at least 1.75 inches, and/or at least 2 inches. Like device 1200, device 1300 also includes a lip 1310 configured such that the lip 1310 and device 1300 can be friction fit to a blower tube.

Device 1300 may include any of the features described with reference to any of the other noise reducing devices described herein, including a primary flow path 1303 leading to primary outlet 1304 and a plurality of secondary phase shifting flow paths leading to a plurality of secondary phase shifting outlets 1308. Primary flow path inlet 1302 and secondary phase shifting flow path inlets 1306 are shown in the front view of FIG. 13B, and helical phase shifting flow paths are shown in the side view of FIG. 13C.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

1. A noise reducing device for reducing the noise of sound waves propagating through a fluid, the device comprising:
a housing;
a primary flow path within the housing extending from a primary inlet to a primary outlet, the primary flow path configured to receive a first portion of the fluid; and
at least one phase shifting flow path within the housing extending from at least one secondary inlet to at least one secondary outlet, the at least one phase shifting flow path configured to receive a second portion of the fluid, wherein the primary flow path is configured such that the first portion of the fluid flowing through the primary flow path produces a first sound wave, and wherein the at least one phase shifting flow path is configured such that the second portion of the fluid flowing through the phase shifting flow path produces a second sound wave out of phase relative to the first sound wave, such that the second sound wave destructively interferes with the first sound wave to reduce noise of the first sound wave.

2. The device of claim 1, wherein producing the second sound wave out of phase relative to the first sound wave causes the first sound wave and second sound wave to destructively interfere with one another downstream of the housing.

3. The device of claim 1, wherein the at least one phase shifting flow path comprises a helical portion that extends along at least a portion of the housing between the at least one secondary inlet and the at least one secondary outlet.

4. The device of claim 3, wherein the helical portion of the at least one phase shifting flow path extends helically around the primary flow path.

5. The device of claim 1, wherein the at least one phase shifting flow path is positioned radially outward of the primary flow path on the device.

6. The device of claim 1, wherein a length of the at least one phase shifting flow path is greater than a length of the primary flow path.

7. The device of claim 1, wherein the phase shifting flow path is configured to produce the second sound wave such that it is 180 degrees out of phase relative to the first sound wave.

8. The device of claim 1, wherein the first and second sound waves comprise frequencies between 1.5 kHz and 5.5 kHz.

9. The device of claim 1, wherein the first and second sound waves comprise frequencies between 2 kHz and 5 kHz.

10. The device of claim 1, wherein a length of the at least one phase shifting flow path is greater than a wavelength of the first sound wave.

11. The device of claim 1, wherein the second portion of the fluid flowing through the at least one phase shifting flow path produces a first plurality of sound waves that are out of phase with a second plurality of sound waves produced by the first portion of the fluid flowing through the primary flow path such that the first and second plurality of sound waves destructively interfere with one another downstream of the device.

12. The device of claim 1, wherein the secondary inlet of the at least one phase shifting flow path is positioned at the same longitudinal location as the primary inlet on an inlet surface of the housing.

13. The device of claim 1, wherein the secondary outlet of the at least one phase shifting flow path is positioned at the same longitudinal location as the primary outlet on an outlet surface of the housing.

14. The device of claim 13, wherein the secondary outlet of the at least one phase shifting flow path is positioned radially outward of the primary outlet on the outlet surface of the housing.

15. The device of claim 13, wherein the secondary outlet of the at least one phase shifting flow path is configured such that the second portion of the fluid combines with the first portion of the fluid downstream of the secondary outlet of the at least one phase shifting flow path.

16. The device of claim 1, wherein the device is configured to be attached to a blower tube or an intake of a blower apparatus.

17. A method for phase shifting sound waves propagating through a fluid, the method comprising:
receiving a fluid at a device for phase shifting sound waves propagating through the fluid, the device comprising:
a housing;
a primary flow path extending from a primary inlet to a primary outlet; and
at least one phase shifting flow path comprising a secondary inlet and a secondary outlet;
receiving a first portion of the fluid into the primary flow path via the primary inlet;
receiving a second portion of the fluid into the at least one phase shifting flow path via the secondary inlet;
shifting a phase of the at least one sound wave propagating through the second portion of the fluid such that the at least one sound wave is out of phase with a corresponding sound wave propagating through the first portion of the fluid.

18. The method of claim 17, comprising:
directing the first portion of the fluid flow out of the primary outlet; and
directing the second portion of the fluid out of the secondary outlet such that the at least one sound wave destructively interferes with the corresponding sound wave downstream of the primary outlet and the secondary outlet, wherein the primary outlet and the secondary outlet are located on a rear surface of the device and configured such that the first portion of the fluid and the second portion of the fluid combine downstream of the primary outlet and the secondary outlet.

19. The method of claim 17, wherein the at least one phase shifting flow path extends helically along at least a portion of the housing between the secondary inlet and the secondary outlet.

20. A noise reducing device comprising:
a housing;
a primary flow path along a central portion of the housing extending from a primary inlet to a primary outlet, the primary flow path producing a first sound wave; and
a secondary air flow helically surrounding the primary air flow path, extending from at least one secondary inlet to at least one secondary outlet, the secondary air flow path producing a second sound wave;
wherein the second sound wave is phase shifted from the first sound wave.
